(19) United States
(12) Patent Application Publication
(10) Pub. No.: US 2011/0047842 A1
(43) Pub. Date: Mar. 3, 2011

(54) Shoe Tag

(76) Inventor: Dave Brissenden, Mount Albert (CA)

(21) Appl. No.: 12/549,565

(22) Filed: Aug. 28, 2009

(51) Int. Cl. G09F 23/00

(52) U.S. Cl. 40/636

(57) ABSTRACT

There is provided a tag for attachment to a shoe having shoelaces. The shoe is a standard laced shoe having a pair of opposing retainers which are configured to be secured together by a shoelace threaded through a plurality of lace passages formed on the opposing retainers. The tag includes a web having an upper and lower edge and a plurality of lace retainers configured to receive the shoelace there through. At least one lace retainers is formed on the web adjacent each of the upper and lower edges of the web. The web is dimensioned to permit the tag to be attached between the opposing retainers by threading the shoelace through the lace retainers. The web is further dimensioned to fit between the lace passages of the opposing retainers. The lace retainers preferably consist of grommets and the web is preferably a flexible web having four corners with a grommet positioned adjacent each of the corners. The tag has a display surface upon which an insignia is displayed. The tag is preferably dimensioned to permit the tag to rest flat against the shoe with the display surface oriented away from the shoe.

### FIELD OF THE INVENTION

The invention relates generally to tags and emblems for applying to shoes.

### BACKGROUND OF THE INVENTION

Shoes come in a variety of forms such as loafers, sandals, zippered, clog like shoes and laced shoes. All of these shoes have a mechanism for securing the shoes to the wearer's feet. Laced shoes are an ancient design which incorporates one or more shoelaces for securing the shoes to the wearer's feet. Laced shoes generally have a pair of opposing retainer portions which can be drawn together by means of a shoelace threaded between shoelace apertures formed there on. The shoelace apertures are generally formed as a row on each of the opposing retainer portions with the shoelace apertures oriented to form opposing pairs of shoelace openings. The opposing pairs of shoelace openings permit the shoelace to be threaded through the shoelace openings so as to join the opposing pairs of shoelace openings in a variety of different ways, such as with a chris-crossing or parallel pattern of shoelace weave. To permit the opposing retainer portions to cooperate with the shoelace without causing discomfort to the user, a tongue is usually formed on the shoe to separate the shoelaces from the interior of the shoe. This type of laced shoe is quite commonly used for sneakers, running shoes and most other forms of athletic shoes.

Shoes may be embellished with logos, designs, embellishments or other insignia for the purpose of improving the appearance of the shoe or for displaying information such as a gym membership number. In many cases, the insignia is often formed on a piece of flexible or rigid material which forms part of the body of the shoe. Alternatively, the insignia or embellishment may be formed on a separate member and attached to the shoe by means of sewing, adhesives or even rivets. In some cases, the insignia or embellishment forms a tag which is attached to the side or back of the shoe by either adhesives or by sewing. While these forms of tags are often attractive, they generally require the manufacturer to attach the tag because the tag has to be secured by sewing or adhesive. These types of tags are not suitable for retrofitting onto shoes because of the complex sewing or adhesive setting required to secure the tag. In some cases, the tag may be provided with an aperture which permits the tag to be attached to the shoe by passing the shoelace through the aperture of the tag and then tying off the shoelace. This type of tag can be quickly attached to a shoe; however, these types of tags often become dislodged as a result of the normal flexing the shoe experiences during use. An improved tag for quick and easy attachment to a shoe which overcomes the disadvantages of the prior art is therefore required.

### SUMMARY OF THE INVENTION

In accordance with one aspect of the present invention, there is provided a tag for attachment to a shoe. The shoe the tag is to be used with is a standard laced shoe having a pair of opposing retainers which are configured to be secured together by a shoelace threaded through a plurality of lace passages formed on the opposing retainers. The tag includes a web having an upper and lower edge and a plurality of lace retainers configured to receive the shoelace there through. At least one lace retainers is formed on the web adjacent each of the upper and lower edges of the web. The web is dimensioned to permit the tag to be attached between the opposing retainers by threading the shoelace through the lace retainers. The web is further dimensioned to fit between the lace passages of the opposing retainers.

In accordance with another aspect of the present invention, there is provided an improved shoe tag for attachment to a laced shoe of the type described above. The tag includes a flexible web having corners with a grommet formed on each of said corners. Each grommet is dimensioned to receive the shoelace there through. The flexible web is dimensioned to permit the tag to be attached between the opposing retainers by threading the shoelace through the grommets.

With the foregoing in view, and other advantages as will become apparent to those skilled in the art to which this invention relates as this specification proceeds, the invention is herein described by reference to the accompanying drawings forming a part hereof, which includes a description of the preferred typical embodiment of the principles of the present invention.

### DESCRIPTION OF THE DRAWINGS

FIG. 1 is a top view of a stylized shoe with a shoe tag made in accordance with the present invention mounted thereto.

FIG. 2 is a top view of a shoe tag made in accordance with the present invention.

FIG. 3 is a cross section taken along line A-A of FIG. 1.

In the drawings like characters of reference indicate corresponding parts in the different figures.

### DETAILED DESCRIPTION OF THE INVENTION

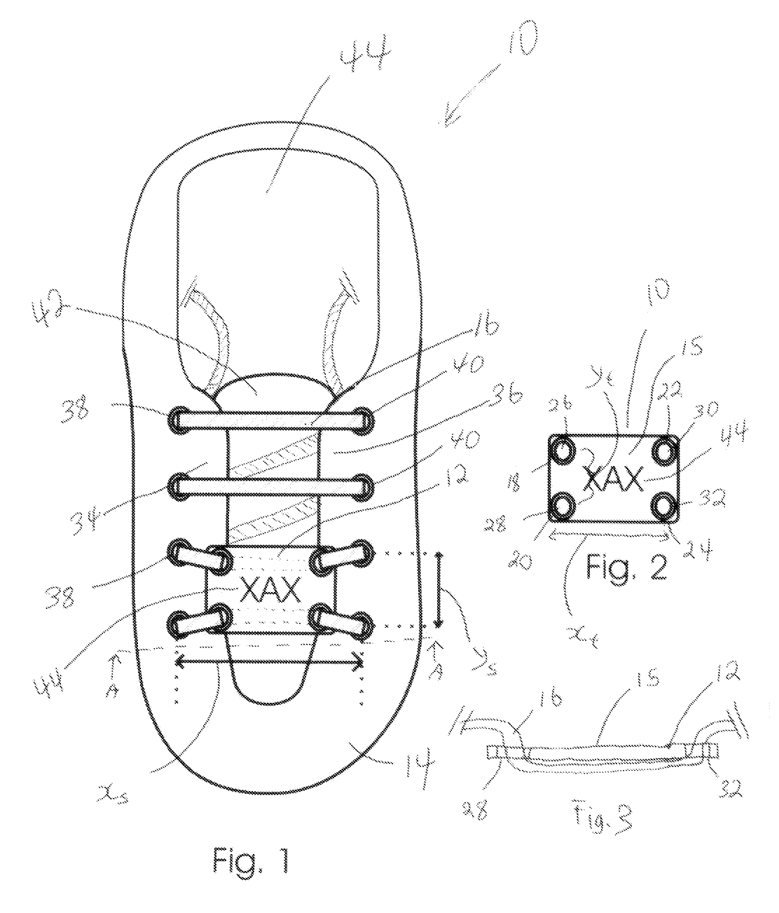

Referring firstly to FIG. 1, a shoe tag made in accordance with the present invention is shown generally as item 10 and consists of web 12 mounted to shoe 14 via shoelace 16. Web 12 is substantially rectangular and has corners 18, 20, 22 and 24 with lace retainers 26, 28, 30 and 32 formed thereon. Lace retainers 26, 28, 30 and 32 are preferably grommets. Grommets 26, 28, 30 and 32 are dimensioned to permit shoelace 16 to be threaded there through. Shoe 14 has opposite retainer portions 34 and 36 with shoelace passages 38 and 40 formed thereon. Shoelace passages 38 and 40 are arranged on retainer portions 34 and 36 such that the shoelace passages are oriented relative to each other as opposing rows to permit shoelace 16 to be threaded between passages 38 and 40 in either a crisscrossing arrangement as shown or a parallel arrangement. Tongue 42 is provided on shoe 14 to separate the shoe interior 44 from shoelace 16.

Shoelace passages 38 and 40 may be any type of structure configured to attach to a shoelace. In the shoe illustrated in FIG. 1, shoelace passages 38 and 40 take the form of grommets; however, it will be appreciated that several other forms of shoe lace retainers can be used in place of grommets. For example, shoelace passages 38 and 40 may consist of hooks, loops, or any other type of structure which has an opening or passage configured to permit a shoelace to pass there through.

Referring now to FIG. 2, web 12 is preferably made of a flexible web like material, preferably from a textile product such as nylon canvas or denim. Grommets 26, 28, 30 and 32 are preferably made of a strong and rigid material such as brass, aluminum, steel or plastic. Commercially available grommets suitable for use in the present invention are easily found in the marketplace. Flexible web 12 has a length (X_{T}) defined as the distance between grommets 26-30 and between grommets 28-32. Flexible web 12 has a width (Y_{T}) which is defined as the distance between grommets 26-28 and between grommets 30 and 32. Flexible web 12 is dimensioned such that when attached to shoe 14 by threading shoelace 16 through grommets 26 to 30 as illustrated in FIG. 1, the flexible web extends substantially flat across shoe 14. In particular, the length of flexible web 12 is no greater than distance between shoelace passages 34 and 36 on opposite retainer portions 34 and 36, respectively, which is shown as distance X_{S} in FIG. 1. Also, the width of flexible web 12 is no greater than the distance between adjacent shoelace passages 38 and 40 on retainer portions 34 and 36, respectively, which is shown as distance Y_{S} in FIG. 1. Preferably, the length of web 12 is less than X_{S} and the width of web 12 is less than Y_{S}, which ensures that tag 10 will fit between the shoe lace retainers and also rest flat across the surface of the shoe. Flexible web 12 is further dimensioned to permit shoelace 16 to pass beneath tag 10 as illustrated in FIG. 3. This permits shoelace 16 to pass between tag 10 and tongue 42 and ensure that the shoelace does not obstruct display surface 15 of tag 10 which has insignia 44 displayed thereon.

By providing a grommet at each corner of the tag and by correctly dimensioning the length and width of flexible web as specified above, shoe tag 10 can be easily attached to a shoe by passing the shoelace below the tag. The tag is preferably mounted between the lowest adjacent pair of opposing shoelace passages, as illustrated in FIG. 1. By attaching the tag at the lowest point on retainer portions 34 and 36 (i.e. between the lowest opposing pairs of shoelace retainers), tag 10 will remain secure regardless of the amount of flexing the shoe encounters. The dimensions of flexible web 12 are important to keep the web flat when mounted to the shoe as illustrated. If the length of the flexible web is too great, then the tag will crumple and may interfere with the lacing of the shoe. If the tag is crumpled, it will distort the appearance of the insignia appearing on the tag. If the tag is made of a rigid inflexible material, then crumpling of the tag may be avoided, particularly if the tag is too large; however, a rigid inflexible tag, particularly one which is too large, will make lacing the shoe more difficult, may decrease the flexibility of the shoe and may increase the amount of wear suffered by the shoe and shoelace.

A specific embodiment of the present invention has been disclosed; however, several variations of the disclosed embodiment could be envisioned as within the scope of this invention. It is to be understood that the present invention is not limited to the embodiments described above, but encompasses any and all embodiments within the scope of the following claims.

Therefore, what is claimed is:

1. A tag for attachment to a shoe having a pair of opposing retainers which are configured to be secured together by a shoelace threaded through a plurality of lace passages formed on the opposing retainers, the tag comprising a web having an upper and lower edge and a plurality of lace retainers configured to receive the shoelace there through, at least one lace retainer formed on the web adjacent each of the upper and lower edges of the web, the web being dimensioned to permit the tag to be attached between the opposing retainers by threading the shoe lace through the lace retainers, the web being further dimensioned to fit between the lace passages of the opposing retainers.

2. The tag defined in claim 1 wherein the flexible web is further dimensioned such that the tag lies substantially flat against the shoe when the tag is attached between the opposing retainers by threading the shoe lace through the lace retainers.

3. The tag defined in claim 1 wherein the web has a surface with an insignia displayed thereon.

4. The tag defined in claim 1 wherein the web has a length and a width, the length of the tag being selected to be no greater than a first distance separating the lace passages on the opposing retainers.

5. The tag defined in claim 4 wherein the width of the tag is selected to be approximately no greater than a second distance separating the lace passages on the same retainer.

6. The tag defined in claim 5 wherein the web has a surface with an insignia displayed thereon, said surface being oriented away from the shoe when the tag is attached to the shoe by threading the shoelace through the lace retainers.

7. The tag defined in claim 2 wherein the web is further dimensioned such that the shoelace can be threaded through the lace retainers and pass between the tag and the shoe.

8. The tag defined in claim 1 wherein the web is flexible and the lace retainers comprise grommets formed on the web.

9. The tag defined in claim 8 wherein the web has four corners and wherein each of the grommets is positioned adjacent one of the corners.

10. A tag for attachment over a tongue of a shoe having a pair of opposing retainers which are configured to be secured together by a shoelace threaded through a plurality of lace passages formed on the opposing retainers, the tag comprising a flexible web having corners with a grommet formed on the flexible web adjacent each of said corners, each grommet being dimensioned to receive the shoelace there through, the flexible web being dimensioned to permit the tag to be attached between the opposing retainers by threading the shoe lace through the grommets.

11. The tag defined in claim 10 wherein the flexible web is further dimensioned such that the tag lies substantially flat against the shoe when the tag is attached between the opposing retainers by threading the shoelace through the grommets.

12. The tag defined in claim 10 wherein the flexible web has a surface with an insignia displayed thereon.

13. The tag defined in claim 10 wherein the flexible web has a length and a width, the length of the tag being selected to be no greater than a first distance separating the lace passages on the opposing retainers.

14. The tag defined in claim 13 wherein the width of the tag is selected to be approximately no greater than a second distance separating the lace passages on the same retainer.

15. The tag defined in claim 14 wherein the flexible web has a surface with an insignia displayed thereon, said surface being oriented away from the shoe when the tag is attached to the shoe by threading the shoelace through the grommets.

16. The tag defined in claim 11 wherein the flexible web is further dimensioned such that the shoelace can be threaded through the grommets and pass between the tag and the shoe.

17. The tag defined in claim 11 wherein the flexible web has four corners.
